(19) United States
(12) Patent Application Publication
(10) Pub. No.: US 2019/0164037 A1
(43) Pub. Date: May 30, 2019

(54) APPARATUS FOR PROCESSING CONVOLUTIONAL NEURAL NETWORK USING SYSTOLIC ARRAY AND METHOD THEREOF

(71) Applicant: ELECTRONICS AND TELECOMMUNICATIONS RESEARCH INSTITUTE, Daejeon (KR)

(72) Inventors: Chan KIM, Daejeon (KR); Young-Su KWON, Daejeon (KR); Hyun Mi KIM, Daejeon (KR); Chun-Gi LYUH, Daejeon (KR); Yong Cheol Peter CHO, Daejeon (KR); Min-Seok CHOI, Daejeon (KR); Jeongmin YANG, Busan (KR); Jaehoon CHUNG, Daejeon (KR)

(73) Assignee: ELECTRONICS AND TELECOMMUNICATIONS RESEARCH INSTITUTE, Daejeon (KR)

(21) Appl. No.: 16/204,599

(22) Filed: Nov. 29, 2018

(30) Foreign Application Priority Data
Nov. 29, 2017 (KR) 10-2017-0162172
Nov. 12, 2018 (KR) 10-2018-0138456

(51) Int. Cl. G06N 3/04; G06N 3/08; G06F 15/80; G06F 17/15

(52) U.S. Cl. CPC G06N 3/04; G06F 17/153; G06F 15/8046; G06N 3/08

(57) ABSTRACT

In the present invention, by providing an apparatus for processing a convolutional neural network (CNN), including a weight memory configured to store a first weight group of a first layer, a feature map memory configured to store an input feature map where the first weight group is to be applied, an address generator configured to determine a second position spaced from a first position of a first input pixel of the input feature map based on a size of the first weight group, and determine a plurality of adjacent pixels adjacent to the second position; and a processor configured to apply the first weight group to the plurality of adjacent pixels to obtain a first output pixel corresponding to the first position, a memory space may be efficiently used by saving the memory space.

### CROSS-REFERENCE TO RELATED APPLICATION

This application claims priority to and the benefit of Korean Patent Application Nos. 10-2017-0162172 and 10-2018-0138456 filed in the Korean Intellectual Property Office on Nov. 29, 2017 and Nov. 12, 2018, respectively, the entire contents of which are incorporated herein by reference.

### BACKGROUND OF THE INVENTION

### (a) Field of the Invention

The present invention relates to an apparatus for processing a convolutional neural network (CNN) using a systolic array and a method thereof.

### (b) Description of the Related Art

Recently, a convolutional neural network (CNN), which is a deep learning network, has mainly been used for image recognition. Currently, much research and developments is being undertaken to accelerate the convolution operation process, which has the greatest operation time among the various stages of processing the convolution neural network, by using dedicated hardware for convolution.

In the convolution neural network, several convolution layers and pooling layers may be used to extract information for locating an object position or object type in the input image finally. In this case, each convolution layer or pooling layer may generate M output feature maps using N input feature maps (input image).

A systolic array (SA) is made up of many PEs (processing elements) that perform the same operation, and many operations may be performed simultaneously by inputting data to each PE. The operation technique using a systolic array has been used for a long time, and recently it has also used in the convolution process to process a deep neural network like the above convolution neural network.

However, by loading the input feature map of the systolic array into the on-chip memory of each systolic array row with a padding area added and if the output feature map is stored in the on-chip memory without the padding area, the output of the previous layer cannot be used as an input in the next layer that requires padding. In order to use the output feature map of the previous layer as an input feature map, the padding area must be arranged in the address to be stored in the external memory through direct memory access (DMA). In addition, when the output feature map is stored in the feature map memory in consideration of the memory space for the padding area, the calculation result of one PE row must be stored in the feature map memory of the next PE row, and there is also a drawback that memory space is wasted. Also, since the output feature map, which is the result calculated with the input feature map, is stored separately in the feature map memory, the memory is used inefficiently.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide an apparatus for processing a convolutional neural network using a systolic array and a method thereof using the operational result for one layer as an input to the operation for a next layer, while using the systolic array easily, and efficiently storing an input feature map and an output feature map.

An exemplary embodiment of the present invention provides an apparatus for processing a convolutional neural network using a systolic array, including: a weight memory configured to store a first weight group of a first layer; a feature map memory configured to store an input feature map to which the first weight group is to be applied; an address generator configured to determine a second position spaced from a first position of a first input pixel of the input feature map based on a size of the first weight group, and to determine a plurality of adjacent pixels adjacent to the second position; and a processor configured to apply the first weight group to the plurality of adjacent pixels to obtain a first output pixel corresponding to the first position.

The processor applies the second weight group of the second layer, which is the next layer after the first layer, to the first output feature map to generate a final output feature map, and the address generator loads the input feature map from an external memory and transmits the final output feature map to the external memory.

The address generator obtains the address information of the input feature map and a plurality of input pixels contained in the input feature map, determines the second position based on the address information of the first position and the size of the first weight group among the address information of the plurality of input pixels, and transmits the second position to the processor.

The address generator obtains address information of the plurality of adjacent pixels, and configures part of the plurality of adjacent pixels to padding based on a result of comparing the address information of the plurality of adjacent pixels and the address information of the plurality of input pixels.

A method for processing a convolutional neural network (CNN) using a systolic array, including: loading an input feature map including a plurality of channels on an address space of a memory; loading an M-th (M is natural number) input pixel of an N-th (N is natural number) channel to an N*(M−1)-th address of the address space; and loading an M-th input pixel of an (N+1)-th channel to an (N+1)*(M−1)-th address of the address space.

The method includes applying a weight to an M-th input pixel of the N-th channel to obtain an N*(M−1)-th output pixel, and storing the N*(M−1)-th output pixel to the N*(M−1)-th address.

The method includes applying a weight to an M-th input pixel of the (N+1)-th channel to obtain an (N+1)*(M−1)-th output pixel, and storing the (N+1)*(M−1)-th output pixel to the (N+1)*(M−1)-th address.

The method includes loading the (M+1)-th input pixel of the N-th channel to the N*M-th address of the address space.

The (M+1)-th input pixel of the N-th channel is a pixel included in a next column after a column including the M-th input pixel of the N-th channel.

The method includes applying a weight to an (M+1)-th input pixel of the N-th channel to obtain an N*M-th output pixel, and storing the N*M-th output pixel to the N*M-th address.

An apparatus for processing a convolutional neural network (CNN) includes: a feature map memory; a weight memory configured to store a first weight group of a first layer; a processor configured to apply the first weight group to an input feature map including a plurality of input channels to generate an output feature map; and an address generator configured to load an M-th input pixel of the N-th input channel to an N*(M−1)-th address in an address space of the feature map memory, load an M-th input pixel of the (N+1)-th input channel to the N+1*(M−1)-th address in the address space of the feature map memory, and store the output feature map by overlapping an address of the address space of the feature map memory where the input feature map is stored.

The processor obtains an N*(M−1)-th output pixel by applying a weight to an M-th input pixel of the N-th channel, and the address generator stores the N*(M−1)-th output pixel in N*(M−1)-th address of the address space of the feature map memory.

The processor obtains an (N+1)*(M−1)-th output pixel by applying a weight to M-th input pixels of the (N+1)-th channel, and the address generator stores the N+1*(M−1)-th output pixel at the (N+1)*(M−1)-th address.

The address generator loads the (M+1)-th input pixel of the N-th channel into the N*M-th address of the address space.

The (M+1)-th input pixel of the N-th channel is the pixel contained in the next column after the column to which the M-th input pixel of the N-th channel belongs.

The processor applies a weight to the (M+1)-th input pixel of the N-th channel to obtain an N*M-th output pixel, and the address generator stores the N*M-th output pixel at the N*M-th address.

The address generator determines a plurality of adjacent pixels to apply the first weight group based on the size of the first weight group, and the processor applies the first weight group to the plurality of adjacent pixels to obtain a first output pixel mapped to the N*(M−1)-th address.

The processor applies a second weight group of a second layer, which is a next layer after the first layer, to the output feature map to generate the final output feature map, and the address generator loads the input feature map from an external memory and transfers the final output feature map to the external memory.

The address generator obtains the input feature map and the addresses of the plurality of input pixels included in the input feature map, and transmits the changed position to apply the first weight group based on the N*(M−1)-th address of the addresses of the plurality of input pixels and the size of the first weight group to the processor, and the processor generates the output feature map by applying the first weight group to a plurality of adjacent pixels adjacent to the changed position.

The address generator configures some of the adjacent pixels as padding based on a result of comparing the address information of the changed locations and the plurality of input pixels.

According to an exemplary embodiment of the present invention, when using systolic arrays, in the feature map memory, the input feature map is loaded from the beginning into the on-chip memory without the padding area, and the output feature map is disassembled into the on-chip memory without the padding area.

Also, according to an exemplary embodiment of the present invention, when performing convolution, batch normalization, activation, and pooling, after the processing of one layer is finished, the output feature map is stored in the feature map memory and is used as the input feature map of the processing for the next layer, and since there is no need to transfer the output feature map to the external memory separately and there is no need to load it separately from the external memory, the access procedure to the external memory may be reduced, and the operation time required for the processing may be further reduced.

Also, according to an exemplary embodiment of the present invention, with the input feature map loaded into the on-chip feature map memory, the output feature map may be saved in real time over the beginning of the space in which the input feature map is stored, allowing for faster output feature map saving and efficient use of limited memory space.

### BRIEF DESCRIPTION OF THE DRAWINGS

FIG. 1 shows an input feature map and an output feature map according to an embodiment of the present invention.

FIG. 2 shows an exemplary embodiment of the CNN processing apparatus according to an embodiment of the present invention.

FIG. 3 shows the detailed configuration of a CNN accelerator according to an exemplary embodiment of the present invention.

FIG. 4 shows the operation of the processor unit according to an exemplary embodiment of the present invention.

FIG. 5 shows an input feature map, an output feature map, and a systolic array according to an exemplary embodiment of the present invention.

FIG. 6 and FIG. 7 show padding according to the conventional art.

FIG. 8 and FIG. 9 show the input feature map and the output feature map according to the conventional art.

FIG. 10 shows an input feature map and an output feature map according to an exemplary embodiment of the present invention.

FIG. 11 shows an address allocation method for memory space according to the conventional art.

FIG. 12 shows an address approaching method according to the conventional art.

FIG. 13 shows an address approaching method according to an exemplary embodiment of the present invention.

FIG. 14 shows the output feature map overwriting the storage space of the input feature map according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

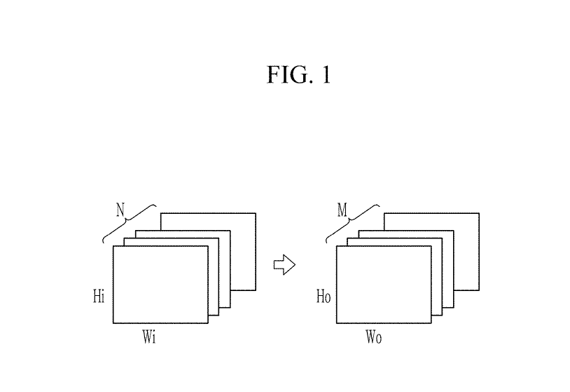

FIG. 1 shows the input feature map and the output feature map according to an embodiment of the present invention.

As shown in FIG. 1, according to an exemplary embodiment of the present invention, each layer of the CNN processor may generate M output feature maps using N input feature maps.

In case of performing convolution, the CNN processor may generate a feature map using different weights of K*K for each N input feature maps, and since these N K*K weights apply different weights for each of the M output feature maps, there are M*N K*K weights.

That is, the value of the output pixel at a particular position in an output feature map is determined by applying a three-dimensional weight of K*K*N around the adjacent input pixels at the corresponding positions of the N input feature maps, the input feature map is multiplied by the values of the input pixels, added together, and then added together with the bias corresponding to the output feature map.

After the convolution, the CNN processor may apply batch normalization to subtract the average value corresponding to the layer, or to divide it by standard deviation or to multiply the desired value by all values. In addition, the CNN processor may apply activation, which is a nonlinear operation in which only a positive number is passed after a convolution or a value is multiplied by a specific value in the case of a negative number. In addition, the CNN processor may perform pooling after such convolution and activation, for example, by selecting the largest value for a given window size, for example, a 2*2 window, or by reducing the size of the feature map. Depending on the implementation, convolution, batch normalization, activation, and pooling may be called individual layers, or a combination of several thereof may be defined as one layer.

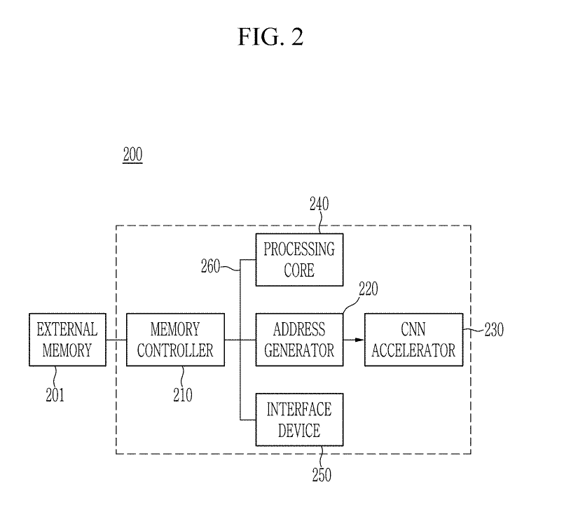

FIG. 2 shows an exemplary embodiment of a CNN processing apparatus according to an embodiment of the present invention.

As shown in FIG. 2, according to an exemplary embodiment of the present invention, the CNN processor 200 may include a memory controller 210 connected to an external memory 201, an address generator 220, a CNN accelerator 230, a plurality of processing cores 240, other interface devices 250, and a bus 260 for connecting them.

The network of the convolution neural network (CNN) may be composed of a plurality of layers, and first input data for a plurality of layers may be stored in the external memory 201. To use the CNN accelerator, the memory controller 210 may be connected to the external memory 201 to transfer data of the external memory 201 to the address generator 210.

The address generator 220 may forward the received input data to the CNN accelerator 230, receive output data from the CNN accelerator 230, and store the received output data in the external memory 201 again.

The CNN accelerator 230 may load the entire input data of the convolution neural network into the on-chip memory (not shown) of the CNN accelerator 230 and sequentially process the entire layer.

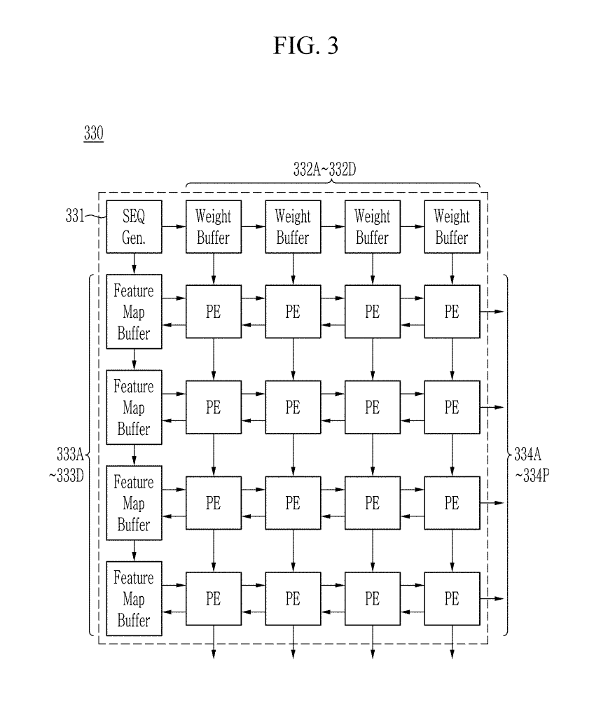

FIG. 3 shows the detailed configuration of a CNN accelerator according to an exemplary embodiment of the present invention.

As shown in FIG. 3, a CNN accelerator 330 may be configured as a systolic array. The systolic array may include a sequence generator 331, a plurality of weight memories 332A-332D, a plurality of feature map memories 333A-333D, and a plurality of processor units 334A-334P.

The plurality of processor units 334A-334P may include SA_H rows and SA_W columns.

The feature map memories 333A-333D may include SA_H memories to store both an input feature map and an output feature map. For one layer, the input feature map is stored in SA_H memory banks. The output feature map, which is the calculation result, is also stored in the SA_H memory banks.

The weight memories 332A-332D may include SA_W memories for storing the weight value. The weight memories store the weight values to create a specific output feature map from each of the N input feature maps. The weight memories may store the K*K*N weights for convolution as well as the average, standard deviation, and scale value for dispose equalization together, if necessary.

Therefore, the CNN processor may generate up to SA_W output feature maps with N input feature maps loaded in the feature map memory. If the number of output feature maps exceeds SA_W, the CNN processor may generate all the output feature maps by repeatedly creating SA_W output feature maps by changing the weight of the weight memory using the loaded N input feature maps, which may be defined as weight tiling of the output feature map unit. If the input feature map is loaded into the feature map memory and the output feature map to be generated as a result cannot be stored in one feature map memory, the CNN processor divides each Wi*Hi input feature map into a plurality of tiles equally by an X or Y direction, and generate SA_W output feature map tiles for each partitioned tile, which may be defined as in-feature map input tiling in the input feature map.

The CNN processor may use input tiling if the input feature map is large. The CNN processor may use weight tiling for each input tile, replacing the contents of the weight memory and creating a tile of the output feature map for that tile.

Each row of a plurality of processor units 334A-334P may process an input feature map provided by the feature map bank corresponding to the row to which it belongs. Each processor unit may receive an input feature map value and an instruction to process from a processor unit located on the left, receive a weight from a processor unit located on the top, and use the received weight and input feature map values to perform an operation corresponding to the command.

A plurality of processor units may store the operation result in an internal register, and transmit the stored output feature map to a processor unit located on the left in the final step. When processing each instruction, each processor unit processes the instruction and simultaneously transmits the instruction and input feature map values received from the left side to a processor unit located on the right, and transmits the weight value received from the top to a processor unit located on the bottom. This allows processor units on the right hand side to use the same input feature map input values that were used on the left, then use the same operation with the weight value corresponding to the output feature map, and the processor units use the same weight value (corresponding to the output feature map they are generating) and use the same value for the same position on another bank of the input feature map to perform the same operation as the upper processor unit.

Thus, processor units located in the same row may generate different output feature maps for that location using different weights for the same input feature map, and processor units located in the same row may use the same weight to generate a corresponding part of the bank of the same output feature map.

The instruction generator 331 generates a command that allows each processor unit to perform convolution, batch normalization, and pooling using the feature map delivered from the feature map memory on the left of each processor unit and the weight value delivered from the upper weight memory, and transmits it to each processor unit.

The command generator 331 may multiply an input feature map value by a weight value to store or accumulate the input feature map value, or generate content indicating that the received weight value is subtracted from the stored value or divided or multiplied for batch normalization. Depending on the implementation, subtraction or division may be replaced by adding or multiplying the inverse of the weight.

The instruction generator 331 may generate a pooling code for instructing to be used for saving the value generated for the pooling window to the internal pooling register, for comparing with the existing pooling register value, or for using the pooling register to average the pooling window and store it to the pooling register.

The instruction generator 331 may also generate an instruction to shift the finally computed output feature maps to the left while passing them to each feature map memory.

Each column of processor units may generate a map of each output feature. Each row of processor units is responsible for each bank where the input feature maps are stored. In addition, the feature maps computed in each row of processor units are passed back to the same memory bank where the input feature map is stored. The CNN processor may divide and store the input feature map so that the pooling operation is performed on the same bank.

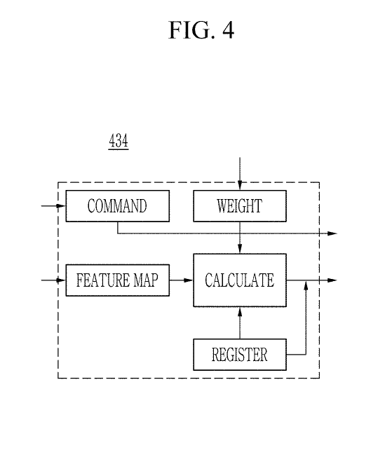

FIG. 4 shows the operation of the processor unit according to an exemplary embodiment of the present invention.

As shown in FIG. 4, the operation that each processor unit 434 should perform is determined by the instruction, which includes receiving the first instruction and passing it to the next processor unit (the processor unit located on the bottom or the right). Since the processor units on the right or below receive the command and the corresponding data arrive at the same time, all the processor units perform the same operation with a time difference.

The processor unit performs N*K*K operations of multiplying and accumulating the weight and the input feature map value to the value of K*K of N input feature maps corresponding to a position of a certain output feature map to be calculated for the convolution, and if necessary, applying batch normalization (subtract the average value, divide it by the standard deviation, and multiply the scale value again) to this value, adding a bias value corresponding to the output feature map, and selecting a maximum value among this plurality of adjacent values (e.g., 2×2) or calculating an average.

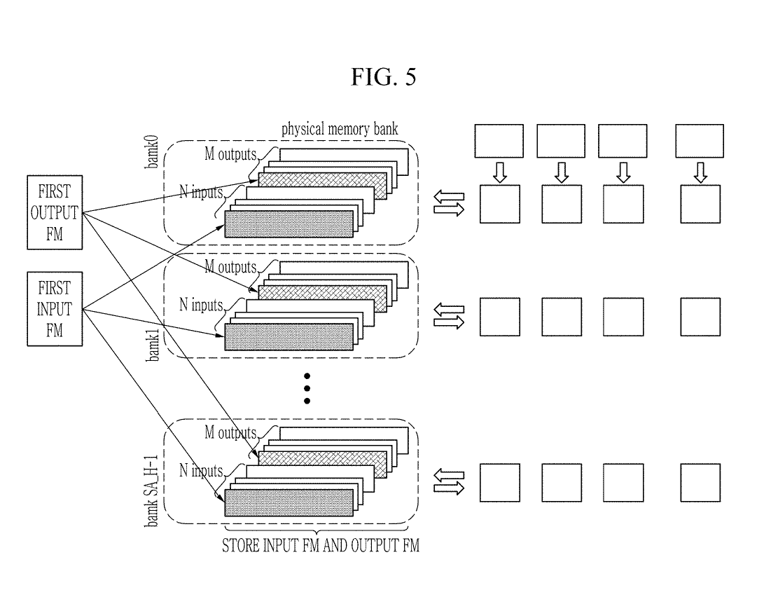

FIG. 5 shows an input feature map and an output feature map and a systolic array according to an exemplary embodiment of the present invention.

As shown in FIG. 5, according to an exemplary embodiment of the present invention, processor units located at the far left and top receive weights, input feature maps, and instructions directly from the address generator (AG) and command generator, and the other processor units may receive input feature maps and weight values from their left and top processor units, respectively. Depending on the implementation, commands may be received from the left or from the top. The same calculation is propagated from the upper left and proceeds to the lower right with a time difference.

The feature map memory may store these calculated output feature maps. The address generator generates an address to be read from the internal memory so that the above operations may be performed, transfers the address to each of the processor units, and creates an address for storing the output feature map when the computed output feature map is received.

The process of generating addresses such as the above method may be different depending on the method of storing data in the left memory and the order of calculation in each processor unit.

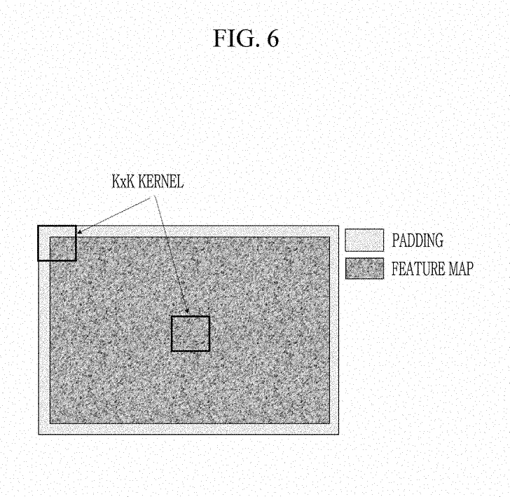

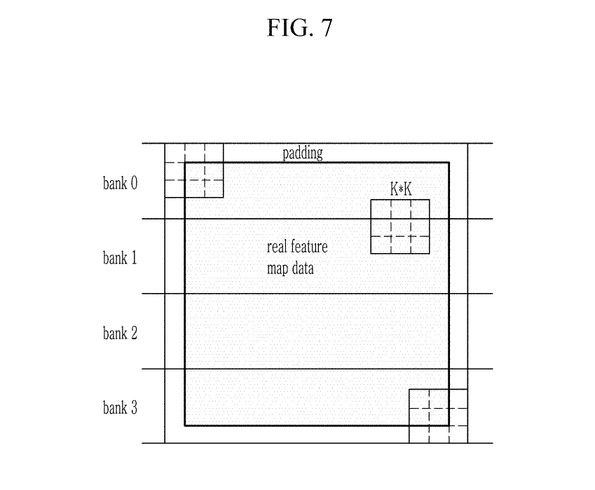

FIG. 6 and FIG. 7 show the padding according to the conventional art.

As shown in FIG. 6, to do the convolution, it is necessary to multiply the weights of K*K around the values of each input feature map, and since there are non-peripheral values of the values at the edge, the padding value is filled. To do convolution for a feature map with a width of Wi and a height of Hi, a padding area of [K/2] (where [K/2] is the largest integer not greater than K/2) rows are required outside the top, bottom, left, and right boundaries of the feature map. The padding value is usually 0. If the weight is 3×3, one row of padding is needed, and if the weight is 5×5, two rows of padding are needed.

As shown in FIG. 7, the conventional art method, when loading input feature maps into the feature map memory for convolution processing through a systolic array, allocates memory space in the padding area required for the convolution. In this method, P=[K/2] rows are added up and down to the original number of feature maps, and then the entire rows are divided into SA_H banks.

If BH is the number of rows that each bank will assume, the height of the original feature map is H, and P paddings are required at each boundary, the entire row including padding is evenly processed by SA_H banks, and the pooling window may be included in the same bank when the pooling is performed. BH may be calculated as BH=[(H+2*P)/SA_H], and the pool pool_win_size of the pooling window may be added to BH.

Because of the padding, the breadth up to the bank is BW=W+2*P. When loading data from the external memory into the feature map memory via the address generator, the space is left empty and the padding area is not filled.

Therefore, the row of each processor unit processes a small input feature map with N number of input channels and a height of BH and a width of BW. When actually reading data for processing, actual data of BH*BW data is read by each bank in this case, so that it is possible to read by the same pattern on entire banks with the difference of one clock (or instruction processing cycle difference), and processing by the systolic array method is available.

When pooling, each of the processor units can process by adding an instruction for adding a loop to the pooling window, and may process several commands for BH*BW data for each bank so as to generate M output feature maps from N input feature maps.

If the original size of the input tile is H, W, and weights of 3×3 are used, the feature map data of (H+2)*(W+2) is placed by adding padding one by one to the top, bottom, left, and right. When loading an input feature map from an external memory via memory loading, the padding is not filled, leaving just a space, and the input feature map is filled with zeros when transmitting to each processor unit.

If SA consists of SA_H rows in a height direction and SA_W columns in a width direction, the feature map memory on the left consists of SA_H physical memories. In order to divide and store the above padded data, BH=[(H+2)*(W+2)/SA_H] rows are stored in one memory.

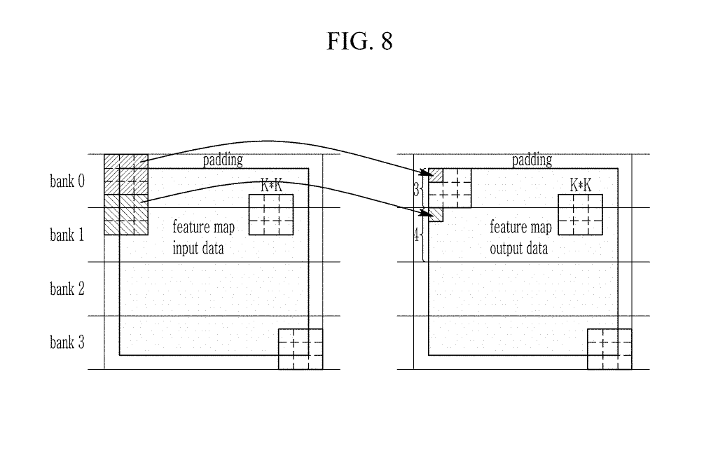

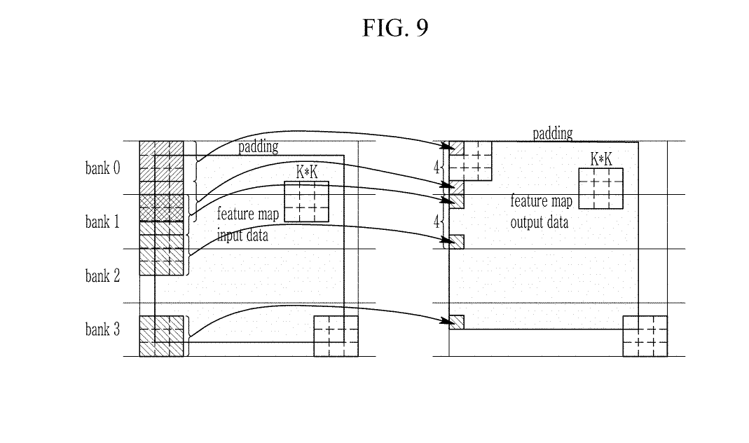

FIG. 8 and FIG. 9 show the input feature map and output feature map according to the conventional art.

As shown in FIG. 8, when SA_H is 4 and H is 14, the input feature map including the padding may be stored in the feature map memory SA_H.

Each processor unit of a systolic array processes an input feature map of its own bank to generate an output feature map. There is a condition that the position of the input feature map data to be processed in the bank and the operation to be taken must be the same, which may be defined as a systolic array condition. Although it is possible to create the address of the input feature map to be read from each bank by taking into account its position, in most cases, a method in which the address generator generates the address to be read and sends the same address to all processor units is mostly used.

If the input feature map is loaded into the feature map memory and there is a padding area, if the next layer is the convolution layer and padding is required, and if the convolution result may be disposed of considering the padding position, it is not necessary to transfer and reload it from the external memory, and it is possible to get very high performance because convolution is performed right away.

However, in order for the input feature map of the feature map memory to include the padding area and the output feature map to be created in the feature map memory to include the padding area, the result must be stored so that the position of the center of K*K weights as shown in FIG. 7 does not change, and in the top and bottom rows, three output rows must be generated. However, since the second and third lines in the middle must produce four output lines, that is, the addresses generated by the address generator may not be used as they are propagated to the lower bank, they fall outside the systolic array condition.

Thus, as shown in FIG. 9, in the case where the padding area is included in the feature map memory, the input feature map necessarily includes padding, but the output feature map cannot be formed in a form that does not include padding.

However, when the input feature map and the output feature map are configured as shown in FIG. 9, it is processed quickly because it is not in violation of the systolic array rules, but the calculated output feature map can not be used in the next layer that requires padding immediately (e.g., in a convolution layer that requires padding), so that there is a drawback that data must be read to include padding.

As shown in FIG. 8 or FIG. 9, if the output feature map is stored in the feature map memory in consideration of the padding space, the output feature map, which is the calculation result of one processor unit row, must be stored in the feature map memory of the next processor unit row, there is also a drawback that there is wasted space in the feature map memory due to padding space.

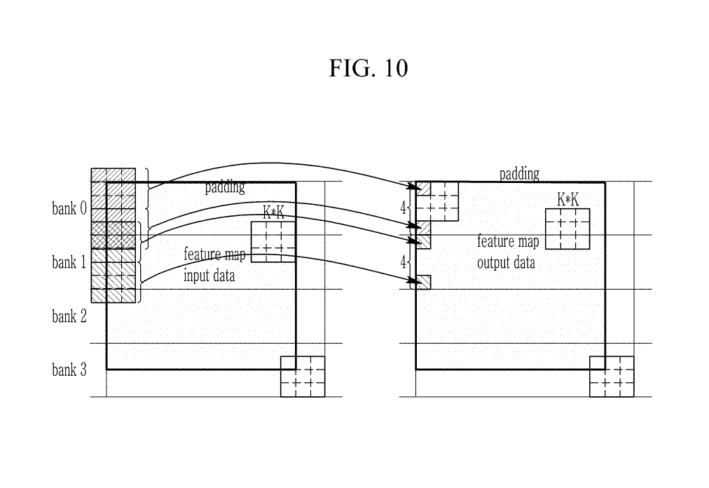

FIG. 10 shows an input feature map and an output feature map according to an exemplary embodiment of the present invention.

As shown in FIG. 10, according to an exemplary embodiment of the present invention, the CNN processor saves memory space by not allocating space from the beginning to the input feature map in the feature map memory but also disposing the output feature map without padding. After processing the layer, data may be stored in the feature map memory so that it may be used as an input to the convolution of the next layer without leaving the external memory.

A CNN processor according to an exemplary embodiment of the present invention uses processor units having SA_H rows and SA_W columns and supplies an input feature map to a row of the corresponding processor unit on the left side of the processor unit array, includes SA_H feature map memories for storing the output feature map from the row of the corresponding processor unit, and the SA_W weight memory for supplying the weight to be used for the row of the corresponding processor unit are provided above the processor unit array.

When loading the input feature map into the SA_H feature map memory through the address generator, the CNN processor according to the present invention may not allocate the memory space for the padding area necessary for applying the KxK weight, and stores only the actual output feature map without padding the padding space, even if the convolution requires padding in the next layer.

Therefore, when loading the input feature map from the address generator, the CNN processor uniformly distributes the height of the original feature map that does not add the padding area to SA_H banks, and when performing pooling, adjusts the output feature map on the same bank included in the same window.

When the convolution is performed as described above, the number of rows BH in the bank to be used may be BH=[H/SA_H], and the rest of BH may be added to BH divided by pool_size.

For example, if the height H of the original input feature is 14, SA_H is 4, and 2*2 pooling together, then [14/4]=4 and 4 is divided by 2, so that BH=4.

In the present invention, when calculating an address, even though the address generator uses the K*K weight section index from 0 to K−1 for each direction, the address generator determines starting coordinates of the pixel group to calculate convolution with the weight by subtracting the value [K/2] corresponding to the amount of padding at that index.

If the calculated index (position of the input pixel groups to calculate the convolution) deviates from the address range of the original input feature map with respect to the width or height direction, the address generator regards this as a padding position, and fills it with 0.

According to an exemplary embodiment of the present invention, an output feature map generated in the above manner may be used as an input feature map of the next layer.

After the output feature map for the Nth layer input feature map is generated, the output feature map may be used as an input to the next layer without being exported to an external memory (DDR3/4) via the address generator.

Through the above method, the entire CNN network may be executed while minimizing the data transfer between the external memory (DDR) and the internal on-chip feature map memory through the address generator, so that the calculation time required for CNN processing may be significantly reduced.

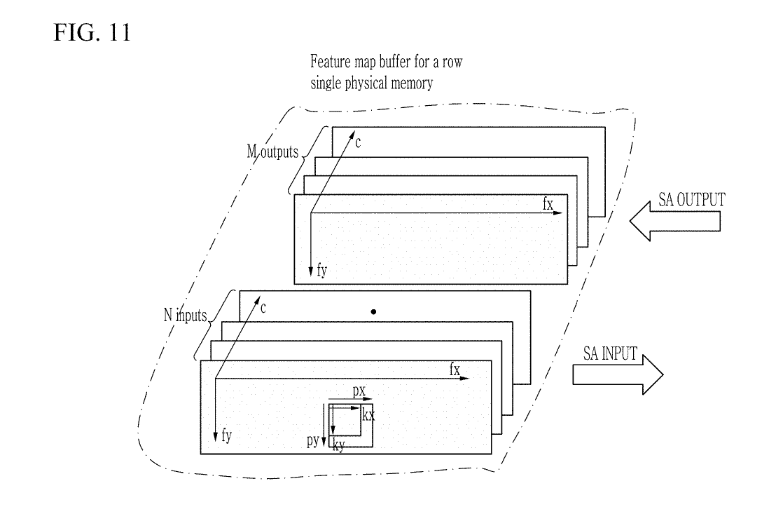

FIG. 11 shows an address allocation method for memory space according to conventional art.

As shown in FIG. 11, each memory bank is a memory, and the address generator generates addresses with a certain rule according to the order of use for data having a three-dimensional structure.

In conventional art, if there are N input feature maps (N channels) of height BH and width BW, the address generator stores the input feature map sequentially in the channel unit, and in the channel, and in a row, it may be stored as a column unit from left to right. In this case, data of row h, column w, of channel c is stored at a (c*BH*BW+h*BW+w)-th address. In this case, each processor unit generates data for one output channel during convolution operation using a systolic array, and since the value must be read in the channel direction since all values of the corresponding positions of all input channels must be used, it processes it every position of a K*K weight to multiply and accumulate N*K*K values.

If the batch normalization is performed, an additional weight corresponding to the corresponding output feature map is used after the MAC (multiplying and accumulating) operation using the weight, the operation of subtracting (adding or subtracting) or multiplying the value to the calculated value is performed, and operates predetermined activation.

If P*P window pooling is performed using a systolic array, there is a drawback that it takes a long time because the maximum value or average value is calculated by performing the above process for each position of this pooling window.

When processing with a systolic array, for an address of the input feature map to be read from each bank, multiple multi-loop counts must be used. Therefore it is possible to previously determine the number of loops and address increment in each loop for each loop based on to the address rule according to the distribution of predetermined data, and to calculate by using method of adding the address increment of itself (lower and inner) relative to the address set in the upper (outer).

The code below represents a method of generating an address of a scheme including steps of processing the coordinates of the output feature map vertically and horizontally, processing pooling positions of vertical and horizontal directions in itself, processing K*K weights for each value, and processing in a channel direction initially for each weight position (in the manner of processing for each of K*K by direction of N).

bw : input width in bank including pad
bh : input height in bank including pad
pl : pooling window size
pd : pad size(=floor K/2)
fy_loop = bh/pl;
fy_inc = bw*pl;
fx_loop = bw-2*pd;
fx_inc = pl;
py_loop = pl;
py_inc = bw;
px_loop = pl;
px_inc = 1;
ky_loop = K;
ky_inc = bw;
kx_loop = K;
kx_inc = 1;
c_loop = N;
c_inc = bw*bh;
fy_addr = in_feature_start_addr;
for (fy=0; fy < fy_loop; fy++) { // loop for sliding window y
fx_addr = fy_addr;
fy_addr += fy_inc;
for (fx=0; fx < fx_loop; fx++) { // loop for sliding window x
py_addr = fx_addr;
fx_addr += fx_inc;
for (py=0; py < py_loop; py++) { // loop for pooling y
px_addr = py_addr;
py_addr += py_inc;
for (px=0; px < px_loop; px++) { // loop for pooling x
ky_addr = px_addr;
px_addr += px_inc;
for (ky=0; ky < ky_loop; ky++) { // loop for Ky
kx_addr = ky_addr;
ky_addr += ky_inc;
for (kx=0; kx < kx_loop; kx++) { // loop for Kx
c_addr = kx_addr;
kx_addr += kx_inc;
for (c=0; c < c_loop; c++) { // loop for in-channel
in_bank_addr = c_addr;
c_addr += c_inc;
ypos = fy*pl + py + ky; // y position in padded in-feature
xpos = fx*pl + px + kx; // x position in padded in-feature
// padding location decod using ypos,xpos and tile, bank boundary info
if (ypos, xpos is padding area)
flag padding;
if (ypos >= bank height) {
bank_id ++; // read next bank
bankaddr = in_bank_addr − (bw*bh);
}
else
bankaddr = in_bank_addr;
read data at bank_id, addr bankaddr, overwrite padding if needed;
} // loop for in-channel
} // loop for Kx
} // loop for Ky
// possible batch-norm and pooling here
} // loop for pooling x, px
} // loop for pooling y, py
} // loop for sliding window x, fx
} // loop for sliding window y, fy

Similarly, the address generation for the data output may be expressed as a pseudo code as follows. Codes represent how to process the feature map vertically and horizontally, and output channels for each position.

bw : output width in bank with no pad
bh : output height in bank with no pad
pl : pooling window size
pd : pad size(=floor K/2)
fy_loop = bh/pl;
fy_inc = (bw-2*pd)/pl;
fx_loop = (bw-2*pd)/pl;
fx_inc = 1;
c_loop = active_systolic_array_columns;
c_inc = (bw-2*pd)/pl*bh/pl;
fy_addr = out_feature_start_addr;
for (fy=0; fy < fy_loop; fy++) { // loop for sliding window y
fx_addr = fy_addr;
fy_addr += fy_inc;
for (fx=0; fx < fx_loop; fx++) { // loop for sliding window x
c_addr = fx_addr;
fx_addr += fx_inc;
for (c=0; c < c_loop; c++) { // # of active systolic array column
out_addr = c_addr;
c_addr += c_inc;
write output data to out_addr;
} // # of active systolic array column (M dir), c
} // loop for sliding window x, fx
} // loop for sliding window y, fy

The rules for reading the weights from each weight memory may be expressed as disclosed below. The weights necessary for all operations are read repeatedly for the data to be generated.

bw : input width in bank including pad
bh : input height in bank including pad
pl : pooling window size
pd : pad size(=floor K/2)
fy_loop = bh/pl;
fy_inc = bw*pl;
fx_loop = bw-2*pd;
fx_inc = pl;
py_loop = pl;
py_inc = bw;
px_loop = pl;
px_inc = 1;
ky_loop = K;
ky_inc = bw;
kx_loop = K;
kx_inc = 1;
c_loop = N;
c_inc = bw*bh;
for (fy=0; fy < fy_loop; fy++) { // loop for sliding window y
for (fx=0; fx < fx_loop; fx++) { // loop for sliding window x
for (py=0; py < py_loop; py++) { // loop for pooling y
for (px=0; px < px_loop; px++) { // loop for pooling x
for (ky=0; ky < ky_loop; ky++) { // loop for Ky
for (kx=0; kx < kx_loop; kx++) { // loop for Kx
for (c=0; c < c_loop; c++) { // loop for N
p = ky*(kx_loop)*(c_loop) + kx*(c_loop) + c;
read addr p;
} // loop for N
} // loop for Kx
} // loop for Ky
for (batch norm and activation weight counts) {
p++, read addr p;
}
} // loop for pooling x, px
} // loop for pooling y, py
} // loop for sliding window x, fx
} // loop for sliding window y, fy

As described above, in the address processing method according to the conventional art, the output feature map, which is the result calculated with the input map in the feature map memory, is stored in a separate space from the input feature map, so it is not efficient.

If the calculated output feature map result is calculated by overlapping the input feature map, then a larger feature map may be loaded at a time, and the process may be performed without performing input feature map tiling (input feature map divided in the XY domain), so that time would be saved.

However, in the above-described method, almost all the addresses of the input feature map are scanned from the beginning because the address is jumped by the channel in the process of scanning the channel in the input process. The output-address map is jumped on a channel-by-channel basis so that the entire feature map is continuously scanned while the output-address map is jumped on a channel-by-channel basis. Even if the user wants to overwrite the input feature map from the beginning, the calculation results will overwrite the later part of the input feature map for later use, making it difficult.

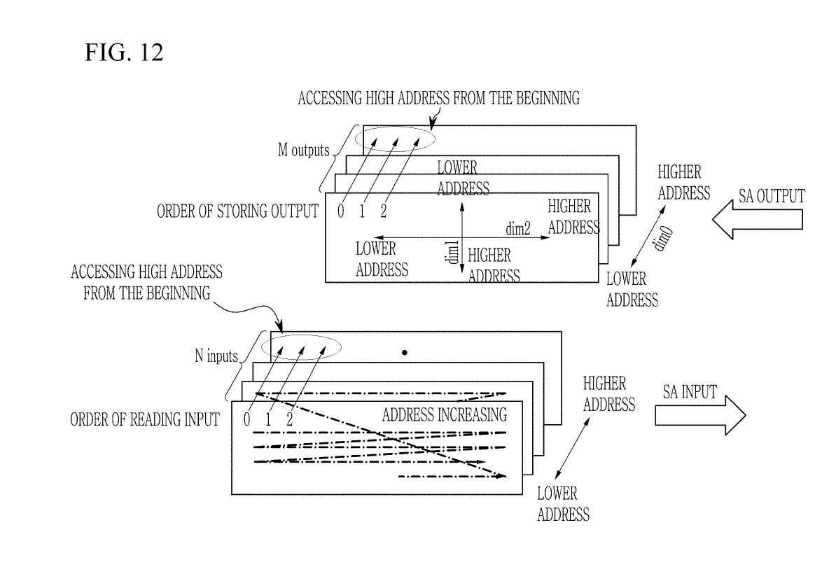

FIG. 12 shows the address approaching method according to the conventional art.

As shown in FIG. 12, according to the conventional art, the address of the memory is determined according to the dim0 (dimension 0) and the low address and the high address in the memory. At the same dim0 level, the low address and the high address are determined according to the dim1. This indicates that the low address and the high address are fixed.

In the conventional art, there is a drawback that when an input feature map is loaded, an address jump occurs to an input channel unit, and when an output feature map is stored, an address jump occurs to an output channel unit, thereby deteriorating the overall operation speed.

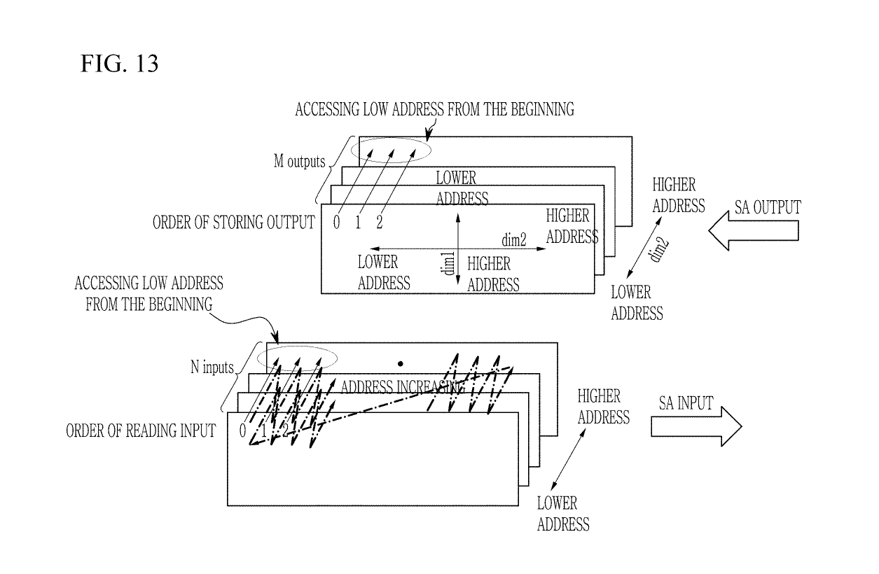

FIG. 13 shows an address approaching method according to an exemplary embodiment of the present invention.

As shown in FIG. 13, according to an exemplary embodiment of the present invention, for CNN processing using a systolic array, the output feature map calculated with data loaded into the feature map memory may be manipulated by overwriting the input feature map from the beginning by using the given memory, so that it is possible to put both the input feature map and the output feature map all at once in the feature map memory to the left of the systolic array.

According to an exemplary embodiment of the present invention, in order to differentiate the address mapping from the conventional method in generating the read address, the increment of the address of each loop may be newly defined. In addition, when the output feature map is stored in the feature map memory according to the characteristic of the systolic array, data should be written at each output channel at the same position for each row of the processor unit. When defining address in the input feature map or output feature map, the same position of each channel is placed in consecutive addresses. Thus, the output feature map may be sequentially written from the initial address to the last address in the address space in the space where the input feature map is stored in memory.

According to an exemplary embodiment of the present invention, the address generator may determine a low address and a high address in memory according to dim0, and a low address and a high address according to dim1 at the same dim0 level. At the same dim1 level, a lower address and a higher address may be set according to dim2.

In the three pseudo codes according to the conventional art, when the K×K convolution is performed on the input feature map of N channels, the first inner loop is first processed in N channel directions. However, according to the present invention, the channel loop may be moved out from the Kernel Y, Kernel X loop.

The code below shows the loop inside the pooling-x modified in the code that increases the feature map read address when the channel loop is placed outside the Kernel Y, Kernel X loop.

for (px=0; px_< px_loop; px++) { // loop for pooling x
c_addr = px_addr;
px_addr += px_inc;
for (c=0; c < c_loop; c++) { // loop for in-channel
ky_addr = c_addr;
c_addr += c_inc;
for (ky=0; ky < ky_loop; ky++) { // loop for Ky
kx_addr = ky_addr;
ky_addr += ky_inc;
for (kx=0; kx < kx_loop; kx++) { // loop for Kx
in_bank_addr = kx_addr;
kx_addr += kx_inc;
ypos = fy*pl + py + ky; // y position in padded in-feature
xpos = fx*pl + px + kx; // x position in padded in-feature
// padding location decode using ypos,xpos and tile, bank boundary info
if (ypos, xpos is padding area)
flag padding;
if (ypos >= bank height) {
bank_id ++; // read next bank
bankaddr = in_bank_addr − (bw*bh);
}
else
bankaddr = in_bank_addr;
read data at bank_id, addr bankaddr, overwrite padding if needed;
} // loop for in-channel
} // loop for Kx
} // loop for Ky
// possible batch-norm and pooling here
} // loop for pooling x, px

If channel loop is moved out of Kernel Y and Kernel X loop, there is no change in the order of output address generation, and the weight reading part may be modified as disclosed below, and the weight may be stored in the modified weight memory.

for (px=0; px < px_loop; px++) { // loop for pooling x
for (ky=0; ky < ky_loop; ky++) { // loop for Ky
for (kx=0; kx < kx_loop; kx++) { // loop for Kx
for (c=0; c < c_loop; c++) { // loop for N
p = ky*(kx_loop)*(c_loop) + kx*(c_loop) + c;
read addr p;
} // loop for N
} // loop for Kx
} // loop for Ky
for (batch norm and activation weight counts) {
p++, read addr p;
}
} // loop for pooling x, px

If the address of the feature map bank is indicated by C code, it is the same as modifying the increment value of each loop and determining the padding area in the previous input feature map reading method as shown below.

bw : input width in bank with no pad
bh : input height in bank with no pad
pl : pooling window size
pd : pad size(=floor K/2)
fy_loop = bh/pl;
fy_inc = N*bw*pl; //bw*pl;
fx_loop = bw;
fx_inc = N*pl; //pl;
py_loop = pl;
py_inc = N*bw; //bw;
px_loop = pl;
px_inc = N; //1;
ky_loop = K;
ky_inc = N*bw; //bw;
kx_loop = K;
kx_inc = N; //1;
c_loop = N;
c_inc = 1; //bw*bh;
fy_addr = in_feature_start_addr;
for (fy=0; fy < fy_loop; fy++) { // loop for sliding window y
fx_addr = fy_addr;
fy_addr += fy_inc;
for (fx=0; fx < fx_loop; fx++) { // loop for sliding window x
py_addr = fx_addr;
fx_addr += fx_inc;
for (py=0; py < py_loop; py++) { // loop for pooling y
px_addr = py_addr;
py_addr += py_inc;
for (px=0; px < px_loop; px++) { // loop for pooling x
ky_addr = px_addr;
px_addr += px_inc;
for (ky=0; ky < ky_loop; ky++) { // loop for Ky
kx_addr = ky_addr;
ky_addr += ky_inc;
for (kx=0; kx < kx_loop; kx++) { // loop for Kx
c_addr = kx_addr;
kx_addr += kx_inc;
for (c=0; c < c_loop; c++) { // loop for in-channel
in_bank_addr = c_addr;
c_addr += c_inc;
ypos = fy*pl + py + ky − pd; // y position in in-feature
xpos = fx*pl + px + kx − pd; // x position in in-feature
if(first_row & ypos < 0))
pad with 0;
else if(xpos < 0))
pad with 0;
else if(xpos >= W))
pad with 0;
else if(last_row & ypos >= last_bank_bank_height))
pad with 0;
else {
if(ypos >= bankheight) { // change to below bank
read next bank at bankaddr = address − pdmai->dst_choffset;
}
else {
read current bank at bankaddr = address;
}
}
read data at bank_id, addr bankaddr, overwrite padding if needed;
} // loop for in-channel
} // loop for Kx
} // loop for Ky
// possible batch-norm and pooling here
} // loop for pooling x, px
} // loop for pooling y, py
} // loop for sliding window x,fx
} // loop for sliding window y, fy

The output address of the feature map is generated by modifying the increment according to the newly defined address system as shown below.

bw : input width in bank with no pad
bh : input height in bank with no pad
pl : pooling window size
pd : pad size(=floor K/2)
fy_loop = bh/pl;
fy_inc = N*bw/pl; // (bw-2*pd)/pl;
fx_loop = bw/pl; // (bw-2*pd)/pl;
fx_inc = N; //1;
c_loop = active_systolic_array_columns;
c_inc = 1; // (bw-2*pd)/pl*bh/pl;
fy_addr = out_feature_start_addr;
for (fy=0; fy < fy_loop; fy++) { // loop for sliding window y
fx_addr = fy_addr;
fy_addr += fy_inc;
for (fx=0; fx < fx_loop; fx++) { // loop for sliding window x
c_addr = fx_addr;
fx_addr += fx_inc;
for (c=0; c < c_loop; c++) { // # of active systolic array column
out_addr = c_addr;
c_addr += c_inc;
write output data to out_addr;
} // # of active systolic array column (M dir), c
} // loop for sliding window x, fx
} // loop for sliding window y, fy

If the data is disposed in the feature map memory and an address is generated and executed, the input feature map is sequentially read from the previous address, and the output feature map is sequentially generated from the first address.

However, in applying the K*K weight to the input feature map, input pixel groups of the input feature map that are mapped to the K*K window are used. In this process, the write address jump may occur. If the starting position of the writing address is sufficiently in front, it is possible to save the output feature map data while overlapping an already used input feature map area and without overwriting the input to be used in the input feature map area already used without overwriting the input to be used in the output feature map data as a calculation result in the process.

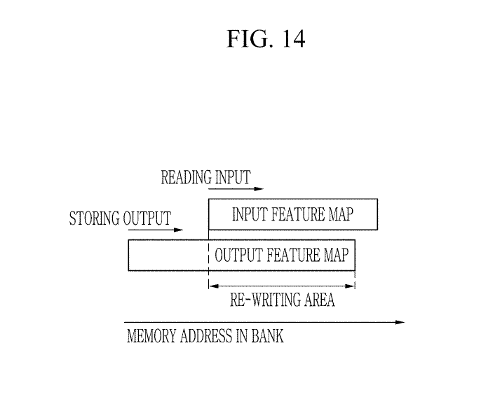

FIG. 14 shows the output of the feature map in the storage space of the input feature map according to an exemplary embodiment of the present invention.

Through the process described in FIG. 11 to FIG. 13, according to an exemplary embodiment of the present invention, the output feature map may be stored while overriding the input feature map, allowing more efficient use of the on-chip feature map memory space given.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for processing a convolutional neural network (CNN), comprising:
a weight memory configured to store a first weight group of a first layer;
a feature map memory configured to store an input feature map where the first weight group is to be applied;
an address generator configured to determine a second position spaced from a first position of a first input pixel of the input feature map based on size of the first weight group, and determine a plurality of adjacent pixels adjacent to the second position; and
a processor configured to apply the first weight group to the plurality of adjacent pixels to obtain a first output pixel corresponding to the first position.

2. The apparatus of claim 1, wherein:
the processor applies the second weight group of the second layer, which is the next layer after the first layer, to the first output feature map to generate a final output feature map; and
the address generator loads the input feature map from an external memory, and transmits the final output feature map to the external memory.

3. The apparatus of claim 2, wherein
the address generator obtains the address information of the input feature map and a plurality of input pixels contained in the input feature map, determines the second position based on the address information of the first position and the size of the first weight group among the address information of the plurality of input pixels, and transmits the second position to the processor.

4. The apparatus of claim 3, wherein
the address generator obtains address information of the plurality of adjacent pixels, and configures part of the plurality of adjacent pixels to padding based on a result of comparing the address information of the plurality of adjacent pixels and the address information of the plurality of input pixels.

5. A method for processing a convolutional neural network (CNN) using a systolic array, comprising:
loading an input feature map including a plurality of channels on address space of a memory;
loading an M-th (M is natural number) input pixel of a N-th (N is natural number) channel on an N*(M−1)-th address of the address space; and
loading an M-th input pixel of an (N+1)-th channel on an (N+1)*(M−1)-th address of the address space.

6. The method of claim 5, comprising:
applying a weight to an M-th input pixel of the N-th channel to obtain an N*(M−1)-th output pixel; and
storing the N*(M−1)-th output pixel on the N*(M−1)-th address.

7. The method of claim 6, comprising:
applying a weight to an M-th input pixel of the (N+1)-th channel to obtain an (N+1)*(M−1)-th output pixel; and
storing the (N+1)*(M−1)-th output pixel at the (N+1)*(M−1)-th address.

8. The method of claim 5, comprising
loading the (M+1)-th input pixel of the N-th channel on the N*M-th address of the address space.

9. The method of claim 8, wherein
the (M+1)-th input pixel of the N-th channel is a pixel included in a next column after a column including the M-th input pixel of the N-th channel.

10. The method of claim 9, comprising:
applying a weight to an (M+1)-th input pixel of the N-th channel to obtain an N*M-th output pixel; and
storing the N*M-th output pixel at the N*M-th address.

11. An apparatus for processing a convolutional neural network (CNN), comprising:
a feature map memory;
a weight memory configured to store first weight group of a first layer;
a processor configured to apply the first weight group to an input feature map including a plurality of input channels to generate an output feature map; and
an address generator configured to load an M-th input pixel of the N-th input channel into an N*(M−1)-th address in an address space of the feature map memory, load an M-th input pixel of the (N+1)-th input channel into the (N+1)*(M−1)-th address in the address space of the feature map memory, and store the output feature map by overlapping on address of the address space of the feature map memory where the input feature map is stored.

12. The apparatus of claim 11, wherein:
the processor obtains an N*(M−1)-th output pixel by applying a weight to an M-th input pixel of the N-th channel; and the address generator stores the N*(M−1)-th output pixel in N*(M−1)-th address of the address space of the feature map memory.

13. The apparatus of claim 12, wherein:
the processor obtains an (N+1)*(M−1)-th output pixel by applying a weight to M-th input pixels of the (N+1)-th channel; and
the address generator stores the (N+1)*(M−1)-th output pixel at the (N+1)*(M−1)-th address.

14. The apparatus of claim 11, wherein
the address generator loads the (M+1)-th input pixel of the N-th channel into the N*M-th address of the address space.

15. The apparatus of claim 14, wherein:
the (M+1)-h input pixel of the N-th channel is the pixel contained in the next column after the column to which the M-th input pixel of the N-th channel belongs.

16. The apparatus of claim 15, wherein:
the processor applies a weight to the (M+1)-th input pixel of the N-th channel to obtain an N*M-th output pixel; and
the address generator stores the N*M-th output pixel at the N*M-th address.

17. The apparatus of claim 11, wherein:
the address generator determines a plurality of adjacent pixels to apply the first weight group based on the size of the first weight group; and
the processor applies the first weight group to the plurality of adjacent pixels to obtain a first output pixel mapped to the N*(M−1)-th address.

18. The apparatus of claim 17, wherein:
the processor applies a second weight group of a second layer that is a next layer after the first layer to the output feature map to generate the final output feature map; and
the address generator loads the input feature map from the external memory and transfers the final output feature map to the external memory.

19. The apparatus of claim 18, wherein:
the address generator obtains the input feature map and the address of the plurality of input pixels included in the input feature map, and transmits the changed position to apply the first weight group based on the N*(M−1)-th address of the address of the plurality of input pixels and the size of the first weight group to the processor; and
the processor generates the output feature map by applying the first weight group to a plurality of adjacent pixels adjacent to the changed position.

20. The apparatus of claim 19, wherein
the address generator configures some of the adjacent pixels as padding based on a result of comparing the address information of the changed locations and the plurality of input pixels.
